(19) United States
(12) Patent Application Publication
(10) Pub. No.: US 2018/0176015 A1
(43) Pub. Date: Jun. 21, 2018

(54) Method and Apparatus for Public Key Encryption Scheme RLCE and IND-CCA2 Security

(71) Applicant: Yongge Wang, Matthews, NC (US)

(72) Inventor: Yongge Wang, Matthews, NC (US)

(21) Appl. No.: 15/840,121

(22) Filed: Dec. 13, 2017

Related U.S. Application Data
(60) Provisional application No. 62/435,151, filed on Dec. 16, 2016.

(51) Int. Cl. H04L 9/30; H04L 29/06; H04L 9/08

(52) U.S. Cl. CPC H04L 9/304; H04L 63/0442; H04L 2209/08; H04L 63/123; H04L 9/0825

(57) ABSTRACT

This invention discloses a method and system for generating a private key and a corresponding public key. These keys can be used for encrypting a message into a cipher-text for transmission through an insecure communication channel, and for decrypting said ciphertext into a clear plaintext. The goal of the present invention is to provide encryption and decryption methods of the McEliece type which are capable of improving the security level of a post-quantum cryptosystem. In one embodiment, this object is achieved by three methods: a method for creating a public key from a private linear code generator matrix, a method for encrypting a message into a ciphertext and a method for decrypting the cipher-text into a plaintext. The key generation and encryption methods of the present invention comprises the following steps:
selecting an [n, k] linear code generator matrix Gₛ=[g₀ , . . . , gₙ] over GF(q) as the private key, where k, w, n and q are positive integers and where g₀ , . . . , gₙ₋₁ are length k column vectors; selecting k×1 random matrices C₀ , . . . , C _{w-1}; selecting a k×k non-singular matrix S; selecting an (n+w)×(n+w) matrix A; selecting an (n+w)×(n+w) permutation matrix P; and setting the public key as G=S[g₀ , . . . , g_{n-w}, C₀ , . . . , gₙ₋₁, Cₙ₋₁]AP.
receiving the public key G, which is a k×(n+w) matrix over a finite field GF(q); generating an error vector e having elements in GF(q) and having a predetermined weight t; and encrypting a message vector m, to a ciphertext vector y=mG+e.

The main difference between the proposed cryptosystem and known variants of the McEliece cryptosystem consists in the way the private generator matrix is disguised into the public one by inserting and mixing random columns within the private generator matrix.

### CROSS-REFERENCES TO RELATED APPLICATIONS

This application is entitled to the benefit of Provisional Patent Application Ser. No. U.S. 62/435,151 filed on Dec. 16, 2016.

### U.S. PATENT DOCUMENTS

Marco Baldi, Marco Bianchi, Franco Chiaraluce, Joachim Jakob Rosenthal, and Davide Mose' Schipani. Method and apparatus for public-key cryptography based on error correcting codes. U.S. Pat. No. 9,191,199 B2 (2015)

Martin Tomlinson, Cen Jung Tjhai. Public key cryptosystem based on goppa codes and puf based random generation. U.S. Pat. No. 8,958,553 B2 (2015)

Yongge Wang. Method and Apparatus for Random Linear Code Based Public Key Encryption Schemes. U.S. patent application Ser. No. 15/270,824, filed on Sep. 20, 2016.

Yongge Wang. Method and Apparatus for Quantum Resistant Public Key Encryption Scheme RLCE and IND-CCA2 Security. U.S. Patent application U.S. 62/435,151, filed on Dec. 16, 2016.

### FOREIGN PATENT DOCUMENTS

Martin Tomlinson and Cen Jung Tjhai. Public key encryption using error correcting codes. WO2012066328 A1 (2012)

Eran Kanter, Ido Kanter. A secure and linear public-key cryptosystem based on parity-check error-correcting code. WO2001050675 A2 (2001).

### OTHER PUBLICATIONS

M. Baldi, M. Bodrato, and F. Chiaraluce. A new analysis of the mceliece cryptosystem based on qc-ldpc codes. In Security and Cryptography for Networks, pages 246-262. Springer, 2008.

M. Bardet, J. Chaulet, V. Dragoi, A. Otmani, and J.-P. Tillich. Cryptanalysis of the McEliece public key cryptosystem based on polar codes. In International Workshop on Post-Quantum Cryptography, pages 118-143. Springer, 2016.

D. Bernstein, T. Lange, and C. Peters. Wild McEeliece. In Selected Areas in Cryptography, pages 143-158. Springer, 2011.

D. J. Bernstein. Grover vs. mceliece. In International Workshop on Post-Quantum Cryptography, pages 73-80. Springer, 2010.

D. J. Bernstein, T. Lange, and C. Peters. Attacking and defending the McEliece cryptosystem. In Post-Quantum Cryptography, pages 31-46. Springer, 2008.

T. A Berson. Failure of the mceliece public-key cryptosystem under message-resend and related-message attack. In Proc Crypto, pages 213-220. Springer, 1997.

D. Boneh. Simplified OAEP for the RSA and rabin functions. In Advances in Cryptology-CRYPTO 2001, pages 275-291. Springer, 2001.

A. Canteaut and N. Sendrier. Cryptanalysis of the original mceliece cryptosystem. In International Conference on the Theory and Application of Cryptology and Information Security, pages 187-199. Springer, 1998.

N. Courtois, A. Klimov, J. Patarin, and A. Shamir. Efficient algorithms for solving overdefined systems of multivariate polynomial equations. In EUROCRYPT 2000, pages 392-407. Springer, 2000.

A. Couvreur, P. Gaborit, V. Gauthier-Umaña, A. Otmani, and J.-P. Tillich. Distinguisher-based attacks on public-key cryptosystems using Reed-Solomon codes. Designs, Codes and Cryptography, pages 1-26, 2013.

A. Couvreur, A. Otmañi, and J.-P. Tillich. Polynomial time attack on wild McEliece over quadratic extensions. In Advances in Cryptology-EUROCRYPT 2014, pages 17-39. Springer, 2014.

T. Cover. Enumerative source encoding. IEEE Transactions on Information Theory, 19(1):73-77, 1973.

J.-C. Faugere, V. Gauthier-Umaña, A. Otmani, L. Perret, and J.-P. Tillich. A distinguishes for high-rate mceliece cryptosystems. Information Theory, IEEE Transactions on, 59(10):6830-6844, 2013.

J.-C. Faugere, A. Otmani, L. Perret, and J.-P. Tillich. Algebraic cryptanalysis of McEliece variants with compact keys. In Eurocrypt 2010, pages 279-298. Springer, 2010.

J.-C. Faugere, L. Perret, and F. De Portzamparc. Algebraic attack against variants of mceliece with goppa polynomial of a special form. In Advances in Cryptology-ASIACRYPT 2014, pages 21-41. Springer, 2014.

E. Fujisaki and T. Okamoto. Secure integration of asymmetric and symmetric encryption schemes. In Annual International Cryptology Conference, pages 537-554. Springer, 1999.

C. Hall, I. Goldberg, and B. Schneier. Reaction attacks against several public-key cryptosystem. In International Conference on Information and Communications Security, pages 2-12. Springer, 1999.

K. Kobara and H. Imai. Semantically secure mceliece public-key cryptosystems-conversions for mceliece pkc. In International Workshop on Public Key Cryptography, pages 19-35. Springer, 2001.

P. J. Lee and E. F. Brickell. An observation on the security of McEliece's public-key cryptosystem. In EUROCRYPT'88, pages 275-280. Springer, 1988.

J. Leon. A probabilistic algorithm for computing minimum weights of large error-correcting codes. IEEE Trans. Information Theory, 34(5):1354-1359, 1988.

P. Loidreau and N. Sendrier. Some weak keys in mceliece public-key cryptosystem. In IEEE International symposium on Information Theory, pages 382-382. INSTITUTE OF ELECTRICAL ENGINEERS INC (IEEE), 1998.

R. J. McEliece. A public-key cryptosystem based on algebraic coding theory. DSN progress report, 42(44):114-116, 1978.

R. Misoczki, J.-P. Tillich, N. Sendrier, and P. Barreto. MDPC-McEliece: New McEliece variants from moderate density parity-check codes. In Proc. IEEE ISIT 2013, pages 2069-2073. IEEE, 2013.

H. Niederreiter. Knapsack-type cryptosystems and algebraic coding theory. Prob. Control and Information Theory, 15(2):159-166,1986.

C. Peters. Information-set decoding for linear codes over F_{q}. In Post-Quantum Cryptography, pages 81-94. Springer, 2010.

D. Pointcheval. Chosen-ciphertext security for any one-way cryptosystem. In International Workshop on Public Key Cryptography, pages 129-146. Springer, 2000.

E. Prange. The use of information sets in decoding cyclic codes. IRE Trans. Information Theory, 8(5):5-9, 1962.

N. Sendrier. Encoding information into constant weight words. In Proc. ISIT 2005, pages 435-438. IEEE, 2005.

V. Shoup. OAEP reconsidered. In CRYPTO 2001, pages 239-259. Springer, 2001.

V. M Sidelnikov and S. Shestakov. On insecurity of cryptosystems based on generalized Reed-Solomon codes. Discrete Mathematics and Applications, 2(4):439-444,1992.

J. Stem. A method for finding codewords of small weight. In Coding theory and applications, pages 106-113. Springer, 1989.

Y. Wang. Quantum resistant random linear code based public key encryption scheme RLCE. In 2016 IEEE International Symposium on Information Theory (ISIT), pages 2519-2523, July 2016.

### FIELD OF THE INVENTION

The present invention relates to methods for public-key cryptography encryption schemes based on linear error correcting codes, and to corresponding encryption and decryption apparatus.

The present invention further relates to computerised methods and systems for encrypting and decrypting data using public key encryption techniques, and to computerised methods and systems for communications using such techniques, as well as other applications thereof. The basic types of things that the invention improves include two kinds of techniques. The first technique is a method and system to integrate randomness within linear error-correcting codes' generator matrices. The second technique is a method and system to use randomized generator matrices as public-keys for encryption schemes for secure communications.

### BACKGROUND OF THE INVENTION

Since McEliece encryption scheme (McEliece 1978) was introduced more than thirty years ago, it has withstood many attacks and still remains unbroken for general cases. It has been considered as one of the candidates for post-quantum cryptography since it is immune to existing quantum computer algorithm attacks. The original McEliece cryptographic system is based on binary Goppa codes. Several variants have been introduced to replace Goppa codes in the McEliece encryption scheme though most of them have been broken. Up to the writing of this invention, secure McEliece encryption schemes include MDPC/LDPC code based McEliece encryption schemes (Baldi 2008, Misoczki 2013), Wang's RLCE (2016), and the original binary Goppa code based McEliece encryption scheme. Sidelnikov and Shestakov (1992) showed that, for the generalized Reed-Solomon code based McEliece encryption scheme, one can efficiently recover the private parameters for the generalized Reed-Solomon code from the public key. Couvreur et al (2013) proposed a general distinguisher based filtration technique to recover keys for generalized Reed-Solomon code based McEliece scheme. The filtration attack was used by Couvreur et al (2014) and Faugere et al (2014) to attack Bernstein et al's (2011) wild Goppa code based McEliece scheme.

Unless specified otherwise, we will use q=p^{m} where p=2 or p is a prime. Our discussion will be based on the field G F(q) through out this paper. Letters such as a, b, e, f, g are used to denote row or column vectors over CF(q). It should be clear from the context whether a specific letter represents a row vector or a column vector. Let k<n<q. The generalized Reed-Solomon code GRSₖ(x, y) of dimension k is defined as

GRS ₖ(x,y)={(y₀p(x₀), . . . , yₙ₋₁p(xₙ₋₁)):p(x)∈ CF(q)[x],deg(p)<k}

where x=(x₀ , . . . , xₙ₋₁)Å CF(q)ⁿ is an n-tuple of distinct elements and y=(y₀ , . . . , yₙ₋₁)Å GF(q)ⁿ is an n-tuple of nonzero (not necessarily distinct) elements.

Several inventors have created several types of techniques to design improved McEliece type public key encryption schemes. U.S. patent application Ser. No. 15/270,824 by Wang (2016) discloses a protocol called RLCE Encryption scheme. The RLCE consists of the following three processes: RLCE.K eySetup, RLCE.Enc, and RLC E.Dec.

RLCE.KeySetup(n, k, d, t, r). Let n, k, d, t>0, and r>1 be given parameters such that n−k+1 ≥d≥2t+1. Let Gₛ=[g₀ , . . . , gₙ₋₁] be a k×n generator matrix for an [n, k, d,] linear code such that there is an efficient decoding algorithm to correct at least t errors for this linear code given by Gₛ.
1. Let C₀, C₁, . . . , Cₙ₋₁Å GF(q)^{k×r} be k×r matrices drawn uniformly at random and let

G₁=[g₀;C₀;g₁;C₁ . . . , gₙ₋₁,Cₙ₋₁]

be the k×n(r+1) matrix obtained by inserting the random matrices Cᵢ into Cₛ.
2. Let A₀ , . . . , Aₙ₋₁Å GF(q)^{(r+1)×(r+1)} be dense nonsingular (r+1)×(r+1) matrices chosen uniformly at random and let

$$A = [ \begin{matrix}{A}_{0} & & & \\ & {A}_{1} & & \\ & & ⋱ & \\ & & & {A}_{n - 1}\end{matrix} ]$$

be an n(r+1)×n(r+1) nonsingular matrix.
3. Let S be a random dense k×k nonsingular matrix and P be an n(r+1)×n(r+1) permutation matrix.
4. The public key is the k×n(r+1) matrix G=SG₁AP and the private key is (S₁Gₛ; P, A).

RLCE.Enc(G,m,e). For a row vector message m ∈ GF(q)^{k}, choose a random row vector e=[e₀ , . . . , eₙ₍ᵣ₊₁₎₋₁]Å GF(q)^{n(r+1)} such that the Hamming weight of e is at most t. The cipher text is c=mG+e.

RLCE.Dec(S,Gₛ, P, A, c). For a received cipher text c=[c₀ , . . . , cₙ₍ᵣ₊₁₎₋₁], compute

cP⁻¹A⁻¹=mSG₁+eP⁻¹A⁻¹=[c′₀ , . . . , c′ₙ₍ᵣ₊₁₎₋₁].

Let c′=[c′₀, c′ᵣ₊₁ , . . . , c′₍ₙ₋₁₎₍ᵣ₊₁₎] be the row vector of length n selected from the length n(r+1) row vector cP⁻¹A⁻¹. Then c′=mSGₛ+e′ for some error vector e′Å GF(q)ⁿ. Let e″=eP⁻¹=[e″₀ , . . . ; e″ₙ₍ᵣ₊₁₎₋₁] and e″ᵢ=[e″ᵢ₍ᵣ₊₁₎ , . . . , e″ᵢ₍ᵣ₊₁₎₊ᵣ] be a sub-vector of e″ for i≤n−1. Then e′[i] is the first element of e″ᵢAᵢ⁻¹. Thus e′[i]≠0 only if e″ᵢ is non-zero. Since there are at most t non-zero sub-vectors e″ᵢ, the Hamming weight of e′Å GF(q)ⁿ is at most t. Using the efficient decoding algorithm, one can compute m′=mS and m=m′S⁻¹. Finally, calculate the Hamming weight w=weight (c−mG). If w≤t then output m as the decrypted plaintext. Otherwise, output error.

Though the RLCE scheme in Wang's patent application U.S. Ser. No. 15/270,824 is secure, it has the disadvantage that the public keys are extremely large and ciphertexts is very large also.

U.S. Pat. No. 9,191,199 B2 to Baldi, Bianchi, Chiaraluce, Rosenthal, and Schipani (2015) discloses a method for designing McEliece cryptosystem based public key encryption schemes by defining n×n transformation matrices Q with form Q=R+T, where the matrix R is a rank-z matrix and the matrix T is some other matrix rendering Q non-singular. Using this family of Q matrices instead of McEliece scheme's permutation matrices, the inventors proposed a cryptosystem using Goppa codes and RS codes. The afore mentioned patent is related to constructing McEliece type encryption schemes by modifying the permutation matrix content instead of adding randomness to the generator matrices columns and is limited in adding sufficient randomness in the public keys to make the scheme secure. U.S. Pat. No. 8,958,553 B2 to Tomlinson and Tjhai (2015) discloses a method for providing additional features to the original McEliece system which enhance the bandwidth efficiency. This patent assumes the existence of a secure McEliece type encryption scheme which is a very strong assumption. Thu this patent is very limited in applications. This patent is also published as the international patent WO2012066328 A1 (2012). The international patent WO2001050675 A2 to Kanter and Kanter (2001) discloses a method for randomly flipping some or all of the bits in a McEliece encryption public-key. This patent is limited in generating a sequence of public keys instead of one public keys. Thus it is not efficient in practice.

### SUMMARY OF THE INVENTION

The goal of the present invention is to provide encryption and decryption methods of McEliece type which are capable of improving the security level of a cryptosystem. In this invention, the term “cryptosystem” is to be understood as relating to both a method of encryption and a corresponding method of decryption.

This objective is achieved by three methods: a method for creating a public key from a private linear code generator matrix, a method for encrypting a message to a ciphertext and a method for decrypting the ciphertext. The key generation and encryption methods of the present invention comprise the following steps:
selecting an [n, k] linear code generator matrix Gₛ over GF(q), where k, r, n, w and q are positive integers; selecting n×n permutation matrix P₁ and letting G₁=[g₀ , . . . , gₙ₋₁]=GₛP₁ where g₀ , . . . , gₙ₋₁ are length k column vectors; selecting k×1 random matrices C₀, . . . ; C_{w-1}; selecting a k×k non-singular matrix S; selecting an (n+w)×(n+w) matrix A; selecting an (n+w)×(n+w) permutation matrix P₂; and setting the public key as G=S[g₀ , . . . ; g_{n-w}, C₀ , . . . , gₙ₋₁; C_{w-1}]AP₂.
receiving a public key G, which is a k×(n+w) matrix over a finite field GF(q); generating an error vector e having elements in GF(q) and having a predetermined weight t; and encrypting a message vector m to a ciphertext vector y=mG+e.
   The main difference between the proposed cryptosystem and known variants of the McEliece cryptosystem consists in the way the private generator matrix is disguised into the public one by inserting and mixing random columns within the private generator matrix.

### BRIEF DESCRIPTION OF THE DRAWINGS

For a more complete understanding of the invention, reference is made to the following description and accompanying drawings, in which:

FIG. 1 is a schematic diagram illustrating a process according to an embodiment of the invention, showing steps taken for generating a private key and steps taken for generating a corresponding public key for a public key encryption scheme;

FIG. 2 is a schematic diagram illustrating a process according to an embodiment of the invention, showing steps taken for encrypting a message using a public key and steps taken for decrypting a cipher text using a corresponding private key;

FIG. 3 is a schematic diagram illustrating RLCE simple padding process according to an embodiment of the invention, showing steps taken for padding a message before using the RLCE encryption mechanism; and

FIG. 4 is a schematic diagram illustrating RLCE padding process according to an embodiment of the invention, showing steps taken for padding a message before using the RLCE encryption mechanism.

### DETAILED DESCRIPTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

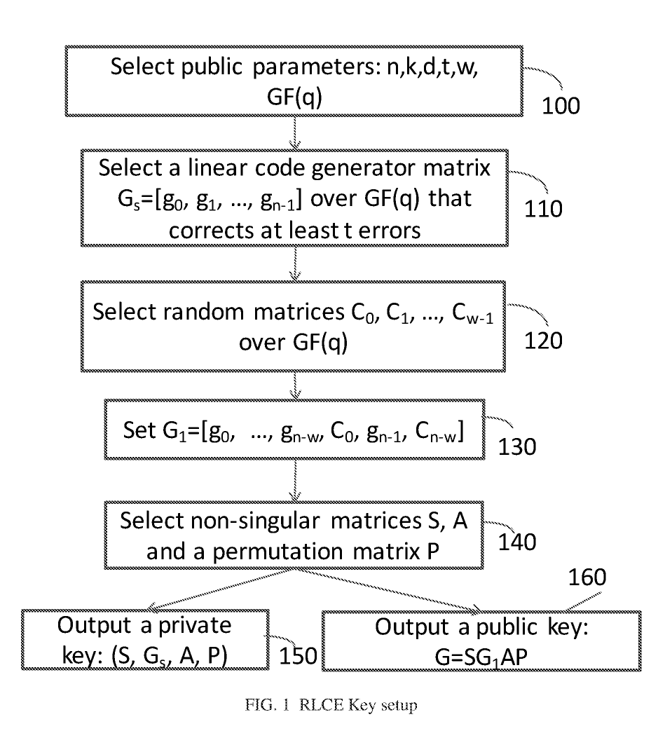

The Random Linear Code based Encryption scheme RLCE reported in the present invention is described in the following paragraphs. FIG. 1 describes a process for generating a private key and for generating a corresponding public key for the proposed public key encryption scheme. Referring therefore to FIG. 1, the public parameter selection engine 100 chooses n, k,d,t,w>0, and GF(q) with the property that n−k+1≥d ≥2t+1. The private linear code generator matrix selection engine 110 chooses a k×n generator matrix Gₛ=[g₀ , . . . , gₙ₋₁] for an [n, k, d] linear code such that there is an efficient decoding algorithm to correct at least t errors for this linear code given by Cₛ. Random matrix selection engine 120 chooses k×1 matrices C₀, C₁ , . . . , C_{w-1}Å GF(q)^{k×1} uniformly at random. Matrix column mixing engine 130 defines

G₁=[g₀, g₁ ; . . . , g_{n-w},C₀ . . . , gₙ₋₁,C_{w-1}] (1)

to be a k×(n+w) matrix by inserting random matrices C₀, C₁ , . . . , C_{w-1} into Gₛ. The second random matrix selection engine 140 chooses dense nonsingular 2×2 matrices A₀ , . . . ; Aₙ₋₁Å GF(q)^{2×2} uniformly at random and defines

$$A = diag [ {I}_{n - w} , {A}_{0} , … , {A}_{w - 1} ] = [ \begin{matrix}{I}_{n - w} & & & \\ & {A}_{0} & & \\ & & ⋱ & \\ & & & {A}_{w - 1}\end{matrix} ] \qquad ( 2 )$$

to be an (n+w)×(n+w) nonsingular matrix. The engine 140 also chooses a random dense k×k nonsingular matrix S and chooses a random (n+w)×(n+w) permutation matrix P. The private key 150 is the tuple (S; Gₛ; P, A) and the public key 160 is the k×(n+w) matrix G=SG₁AP.

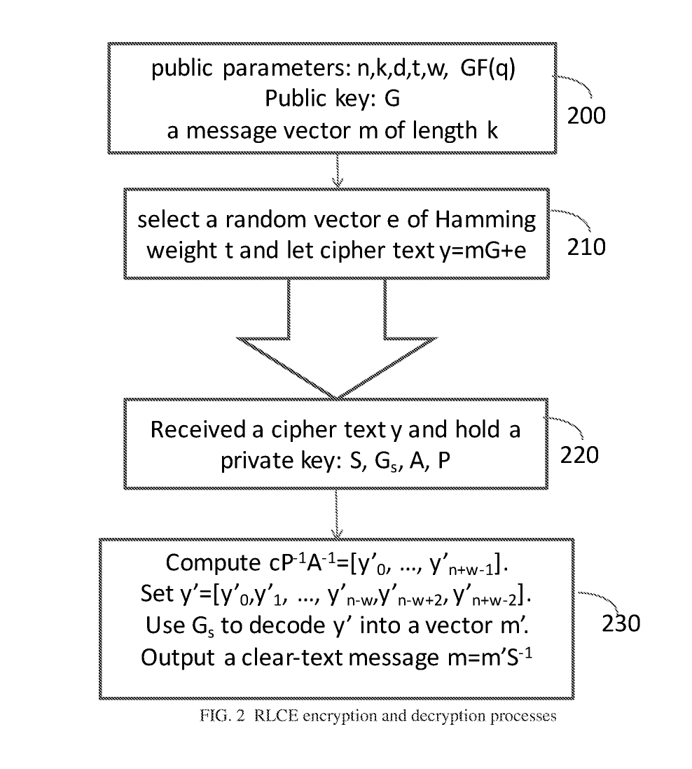

FIG. 2 describes a process for encrypting a clear text message using the public key 160 of FIG. 1 and a process for decrypting a ciphertext to a clear text message using the private key 150 of FIG. 1. Referring therefore to FIG. 2, for given public parameters n, k, d, t, w, GF(q), a public key G, and a row message vector mÅ GF(q)^{k} in the box 200, the encryption engine 210 chooses a random row vector e=[e₀ . . . , e_{n+w-1}] Å CF(q)^{n+w} whose Hamming weight is at most t and computes the cipher text as y=mG+e. The receiver 220 holds the private key S, G ₛ, A, P and receives the ciphertext y. For the received cipher text y=[y₀ , . . . , y_{n+w-1], the decryption engine 230 computes}

yP⁻¹A⁻¹=[y′₀ , . . . , y′_{n+w)-1}]=mSG₁+eP⁻¹A⁻¹.

Let y′=[y′₀,y′₁ , . . . , y′_{n-w}, y′_{n-w+2}; y′_{n-w+4} , . . . , y′_{n+w-2}] be a length n row vector selected from the length n+w row vector yP⁻¹A⁻¹. Then y′=mSGₛ+e′ for some error vector e′Å GF(q)ⁿ where the Hamming weight of e′Å GF(q)ⁿ is at most t. Using the efficient decoding algorithm, the receiver computes m′=mS and m=m′S⁻¹. Finally, the receiver calculates the Hamming weight w=weight(y−mG). If w≤t then the decryption engine 230 outputs m as the decrypted plaintext. Otherwise, the decryption engine 230 outputs an error. The RLCE scheme described above could be formally described as follows with three procedures: RLCE.KeySetup, RLCE.Enc, and RLCE.Dec.

RLCE.KeySetup(n,k,d,t,w). Let n, k,d,t>0, and w Å {1 , . . . , n} be given parameters such that n−k+1≤d≤2t+1. Let Gₛ be a k×n generator matrix for an [n,k,d] linear code C such that there is an efficient decoding algorithm to correct at least t errors for this linear code given by Gₛ. Let P₁ be a randomly chosen n×n permutation matrix and GₛP₁=[g₀ , . . . , gₙ₋₁].
1. Let r₀, r₁ , . . . , r_{w-1} Å GF(q)^{k} be column vectors drawn uniformly at random and let

G₁=[g₀ , . . . , g_{n-w};r₀ , . . . , gₙ₋₁,r_{w-1}] (3)

be the k×(n+w) matrix obtained by inserting column vectors r, into Gₛ.
2. Let

$${A}_{0} = ( \begin{matrix}{a}_{0 , 00} & {a}_{0 , 01} \\ {a}_{0 , 10} & {a}_{0 , 11}\end{matrix} ) , … , {A}_{w - 1} = ( \begin{matrix}{a}_{w - 1 , 00} & {a}_{w - 1 , 01} \\ {a}_{w - 1 , 10} & {a}_{w , 1 , 11}\end{matrix} )$$

Å GF(q)^{2×2} be non-singular 2×2 matrices chosen uniformly at random such that a_{i,00}a_{i,01}a_{i,10}a_{i,11} ≠0 for all i=0 , . . . , w−1. Let A=diag[1 , . . . , 1, A₀ , . . . , A_{w-1}] be an (n+w)×(n+w) non-singular matrix.
3. Let S be a random dense k×k non-singular matrix and P₂ be an (n+w)×(n+w) permutation matrix.
4. The public key is the k×(n+w) matrix G=SG₁AP₂ and the private key is (S, Gₛ; P₁; P₂, A).

RLCE.Enc(G, m, e). For a row vector message m Å GF(q)^{k}, choose a random row vector e=[e₀ , . . . , e_{n+w-1}] Å GF(q)^{n+w} such that the Hamming weight of e is at most t. The cipher text is c=mG+e.

RLCE.Dec(S, Gₛ, P₁, P₂, A, c). For a received cipher text c=[c₀ , . . . , c_{n+w-1}], compute

cP₂⁻¹A⁻¹=mSG₁+eP₂⁻¹A⁻¹=[c′₀ , . . . ; c′_{n+w-1}].

Let c′=[c′₀, c′₁ , . . . , c′_{n-w},c′_{n-w+2} , . . . ; c′_{n+w-2}] be the row vector of length n selected from the length n+w row vector cP₂⁻¹A⁻¹. Then c′P₁⁻¹=mSGₛ+e′ for some error vector e′ Å GF(q)ⁿ where the Hamming weight of e′ Å GF(q)ⁿ is at most t. Using an efficient decoding algorithm, one can recover mSGₛ from c′P₁⁻¹. Let D be a k×k inverse matrix of SG′ₛ where G″ₛ is the first k columns of Gₛ. Then m=c₁D where c₁ is the first k elements of mSGₛ. Finally, calculate the Hamming weight wt=wt (c−mG). If wt≤t then output m as the decrypted plaintext. Otherwise, output error.

To reduce RLCE scheme public key sizes, one can use a semantic secure message encoding approach (e.g., an IND-CCA2 padding scheme) so that the public key can be stored in a systematic matrix. For a McEliece encryption scheme over GF(q), one needs to store k(n−k) elements from F(q) for a systematic public key matrix instead of nk elements from GF(q) for a non-systematic generator matrix public key.

In a systematic RLCE encryption scheme, the decryption could be done more efficiently. In the RLCE decryption process, one recovers mSGₛ from c′P₁⁻¹=mSGₛ+e′ first. Let mSGₛP₁=(d₀ , . . . , dₙ₋₁) and

c_{d} =(d′₀ , . . . , d′_{n+w})=(d₀,d₁ , . . . ; d_{n-w},⊥d_{n-w+1},⊥, . . . , dₙ₋₁;⊥)P₂

be a length n+w vector. For each i<k such that d′ᵢ=dⱼ for some j<n−w, we have mᵢ=dᵢ. Let

I_{R}={i:mᵢ is recovered via mSGₛ} and I̅_{R}={0 , . . . , k−1}\I_{R}.

Assume that |Ī_{R}|=u. It suffices to recover the remaining u message symbols mᵢ with i ∈ Ī_{R}. In the following paragraphs, we present three approaches to recover these message symbols.

Decoding algorithm 0 for systematic RLCE encryption scheme: In the first approach, one recovers mS from mSGₛ first. Then one multiplies m′ with the corresponding u columns S_{Ī}_{_{R}} of the matrix S⁻¹ to get mᵢ with i ∈ Ī_{R}.

Decoding algorithm 1 for systematic RLCE encryption scheme: Instead of recovering mS first, one may use public key to recover the remaining message symbols from mSGₛ directly. Let i₀ , . . . , iᵤ₋₁≥k be indices such that for each iⱼ, we have d′ᵢ_{ⱼ}=dᵢ for some i<n−w. The remaining message symbols with indices in Ī_{R} could be recovered by solving the linear equation system

m[gᵢ_{₀} , . . . , gᵢ_{_{u−1}}]=[d′ᵢ_{₀} , . . . , d′ᵢ_{_{u−1}}]

where gᵢ_{₀} , . . . , gᵢ_{_{u−1}} are the corresponding columns in the public key. Let P be a permutation matrix so that mᵢ (i ∈ I_{R}) are the first k−u elements in mP. That is,

mPP⁻¹[gᵢ_{₀} , . . . , gᵢ_{_{u−1}}]=(m_{I}_{ᵣ},m_{Ī}_{ᵣ})P⁻¹[hᵢ_{₀} , . . . , gᵢ_{_{u−1}}]=[d′ᵢ_{₀} , . . . , d′ᵢ_{_{u−1}}]

where m_{I}_{ᵣ} is the message symbols with indices in I_{R}. Let

$${P}^{- 1} [ {g}_{{i}_{0}} , … , {g}_{{i}_{u - 1}} ] - ( \begin{matrix}V \\ W\end{matrix} )$$

where V is a (k−u)×u matrix and W is a u×u matrix. Then we have

m_{Ī}_{ᵣ}W=[d′ᵢ_{₀} , . . . , d′ᵢ_{_{u−1}}]−m_{I}_{ᵣ}V.

Furthermore, one may pre-compute the inverse of W and include W⁻¹ in the private key. Then one can recover the message symbols

m_{Ī}_{ᵣ}=([d′ᵢ_{₀} , . . . , d′ᵢ_{_{u−1}}]−m_{I}_{ᵣ}V)W⁻¹.

Decoding algorithm 2 for systematic RLCE encryption scheme: In practice, one may use a larger I_{R}. Recall that in the RLCE decryption process, one recovers mSGₛ from c′P₁^{31 1}=mSGₛ+e′ first. Let e′P₁=(e₀ , . . . , eₙ₋₁) and

e_{c}=(e′₀ , . . . , e′_{n+w})=(e₀,e₁ , . . . , e_{n-w},ē_{n-w};e_{n-w+1},ē_{n-w+1} , . . . , eₙ₋₁, ēₙ₋₁)P₂

be a length n+w vector. For each e_{n-w+i}_{₀}=0 (0 ≤i₀<w), if e′ᵢ=e_{n-w+i}_{₀} or e′ᵢ=ē_{n-w+i}_{₀} for some i<k, then with high probability, we have mᵢ =cᵢ since matrices Aᵢ do not contain zero elements. Thus mᵢ might be recovered as cᵢ. Let

I_{R}^{a}32 I_{R}∪{i<k:e′ᵢ=e_{n-w+i}_{₀} or e′ᵢ=ē_{n-w+i}_{₀} for some i₀<w with e_{n-w+i}_{₀}=0}

and Ī_{R}^{a}={0 , . . . , k−1}\I_{R}^{a}. Using the decoding algorithm 1 with (I_{R}, Ī_{R}) replaced by (I_{R}^{a}, Ī_{R}^{a}), one can then recover message symbols with indices in Ī_{R}^{a}. With a small probability, the message recovered via (I_{R}^{a}, Ī_{R}^{a}) might be incorrect. If this happens, one restarts the decoding process using the pair (I_{R}; Ī_{R}).

Defeating side-channel attacks: The decoding algorithm 2 described might be vulnerable to side-channel attacks. The attacker may generate ciphertexts with appropriately chosen error locations and watch whether the decoding time is significantly long (which means that the message recovered via (I_{R}^{a}; Ī_{R}^{a}) might be incorrect). This information may be used to recover part of the private permutation P₂. If such kind of attacks needs to be defeated, then one should not use the decoding algorithm 2.

For the decoding algorithms 0 and 1, the value u is dependent on the choice of the private permutation P₂. Though the leakage of the size of u is not sufficient for the adversary to recover P₂ or to carry out other attacks against RLCE scheme, this kind of side-channel information leakage could be easily defeated. Table 0.1 lists the values of u₀ such that, for each scheme, the value of u is smaller than u₀ for 90% of the choices of P₂ where the RLCE ID is the scheme ID described in Table 0.3. Thus one can select P₂ in such a way that u is smaller than the given u₀ of Table 0.1. Furthermore, during the decoding process, one can use dummy computations so that the decoding time is the same as the decoding time for u=u₀.

TABLE 0.1
The value u₀ for RLCE schemes

| RLCE ID | 0 | 1 | 2 | 3 | 4 | 5 | 6 |
|---|---|---|---|---|---|---|---|
| u₀ | 200 | 123 | 303 | 190 | 482 | 309 | 7 |

Similar to most cryptographic systems, each type of McElience schemes may contain some weak keys and one should avoid using these weak keys when setting up the scheme. For example, Loidreau (1998) pointed out some weak keys for binary Goppa code based McElience schemes. The second straightforward observation is that one can modify an McElience encryption scheme ciphertext c=mG+e without knowing the message m. For example, one can obtain a valid ciphertext for a message m+m′ by setting c′=c+m′G. This kind of attacks could be defeated by using IND-CCA2-secure message padding schemes which will be discussed in the next Section.

Information-set decoding (ISD) is one of the most important message recovery attacks on McEliece encryption schemes. The state-of-the-art ISD attack for non-binary McEliece scheme is the one presented in Peters (2010), which is an improved version of Stern's algorithm (1989). Peters's attack (2010) also integrated analysis techniques for ISD attacks on binary McEliece scheme discussed in literature. For the RLCE encryption scheme, the ISD attack is based on the number of columns in the public key G instead of the number of columns in the private key Gₛ. The cost of ISD attack on an [n, k, t; w]-RLCE scheme is equivalent to the cost of ISD attack on an [n+w, k; t]-McEliece scheme.

For the naive ISD, one first uniformly selects k columns from the public key and checks whether it is invertible. If it is invertible, one multiplies the inverse with the corresponding ciphertext values in these coordinates that correspond to the k columns of the public key. If these coordinates contain no errors in the ciphertext, one recovers the plain text. To be conservative, we may assume that randomly selected k columns from the public key is invertible. For each k x k matrix inversion, Strassen algorithm takes O(k^{2.807}) field operations (though Coppersmith-Winograd algorithm takes O(k^{2.376}) field operations in theory, it may not be practical for the matrices involved in RLCE encryption schemes). In a summary, the naive information-set decoding algorithm takes approximately 2^{k′}^{_{c}} steps to find k-error free coordinates where, by Sterling's approximation,

$$\begin{matrix}{κ}_{c}^{′} = {log}_{2} ( \frac{( \begin{matrix}n + w \\ k\end{matrix} ) ( {k}^{2.807} + {k}^{2} )}{( \begin{matrix}n + w - t \\ k\end{matrix} )} ) \\ ≃ ( n + w ) I ( \frac{k}{n + w} ) - ( n + w - t ) I ( \frac{k}{n + w - t} ) + {log}_{2} ( {k}^{2.807} + {k}^{2} )\end{matrix} \qquad ( 4 )$$

and I(x)=−x log₂(x)−(1−x) log₂(1−x) is the binary entropy of x. There are several improved ISD algorithms in the literature. These improved ISD algorithms allow a small number of error positions within the selected k ciphertext values or select k+δ columns of the public key matrix for a small number δ>0 or both. Peters (2010) provided a script to calculate the security strength of a McEliece encryption scheme using the improved ISD algorithms. For the security strength 128≤κ_{c}≤256, our experiment shows that generally we have κ,′_{c}−10≤κ,_{c}≤κ,′_{c}−4.

An RLCE scheme is said to have quantum security level κ_{q} if the expected running time (or circuit depth) to decrypt an RLCE ciphertext using Grover's algorithm based ISD is 2^{κ}^{_{q}}. For a function ƒ: {0, 1}^{l}→{0, 1} with the property that there is an x₀ ∈{0, 1}¹ such that ƒ(x₀)=1 and ƒ(x)=0 for all x≠x₀, Grover's algorithm finds the value x₀ using

$$\frac{π}{4} \sqrt{{2}^{l}}$$

Grover iterations and O (l) qubits. Specifically, Grover's algorithm converts the function ƒ to a reversible circuit C_{ƒ} and calculates

$$\vert x 〉 {\to }^{{C}_{f}} {( - 1 )}^{f ( x )} \vert x 〉$$

in each of the Grover iterations, where |x [symbol] is an l-qubit register. Thus the total steps for Grover's algorithm is bounded by

$$\frac{π \vert {C}_{f} \vert}{4} \sqrt{{2}^{l}} .$$

For the RLCE scheme, quantum ISD could be carried out similarly as in Bernstein (2010). One first uniformly selects k columns from the public key and checks whether it is invertible. If it is invertible, one multiplies the inverse with the ciphertext. If these coordinates contain no errors in the ciphertext, one recovers the plain text. Though Grover's algorithm requires that the function ƒ evaluate to 1 on only one of the inputs, there are several approaches (see, e.g., Grassl et al (2016)) to cope with cases that ƒ evaluates to 1 on multiple inputs.

For randomly ‘selected k columns from a RLCE encryption scheme public key, the probability that the ciphertext contains no errors in these positions is

$$\frac{( \begin{matrix}n + w - t \\ k\end{matrix} )}{( \begin{matrix}n + w \\ k\end{matrix} )} .$$

### Thus

the quantum ISD algorithm requires

$$\sqrt{( \begin{matrix}n + w \\ k\end{matrix} ) / ( \begin{matrix}n + w - t \\ k\end{matrix} )}$$

Grover iterations. For each Grover iteration, the function ƒ needs to carry out the following computations:
1. Compute the inverse of a k×k sub-matrix G_{sub} of the public key and multiply it with the corresponding entries within the ciphertext. This takes O (k^{2.807}+k²) field operations if Strassen algorithm is used.
2. Check that the selected k positions contain no errors in the ciphertext. This can be done with one of the following methods:
   a) Multiply the recovered message with the public key and compare the differences from the ciphertext. This takes O ((n+w)k) field operations.
   b) Use the redundancy within message padding scheme to determine whether the recovered message has the correct padding information. The cost for this operation depends on the padding scheme.
      It is expensive for circuits to use look-up tables for field multiplications. Using Karatsuba algorithm, Kepley and Steinwandt (2015) constructed a field element multiplication circuit with gate counts of 7·(log₂q)^{1.585}. In a summary, the above function ƒ for the RLCE quantum ISD algorithm could be evaluated using a reversible circuit C_{ƒ}with O (7((n+w)k+k^{2.807}+k²) (log₂q)^{1.585}) gates. To be conservative, we may assume that a randomly selected k-columns sub-matrix from the public key is invertible. Thus Grover's quantum algorithm requires approximately

$$7 ( ( n + w ) k + {k}^{2.807} + {k}^{2} ) {( {log}_{2} q )}^{1.585} \sqrt{\frac{( \begin{matrix}n + w \\ k\end{matrix} )}{( \begin{matrix}n + w - t \\ k\end{matrix} )}} \qquad ( 5 )$$

steps for the simple ISD algorithm against RLCE encryption scheme. Advanced quantum ISD techniques may be developed based on improved ISD algorithms. However our analysis shows that the reduction on the quantum security is marginal. For each of the recommended schemes in Table 0.3, the row (κ′_{c},κ,_{q}) in Table 0.2 shows the security strength under the classical ISD and classical quantum ISD attacks. For example, the RLCE scheme with ID=1 in Table 0.3 has 139-bits security strength under classical ISD attacks and 89-bits security strength under quantum ISD attacks.

TABLE 0.2
Security strength for RLCE schemes in Table 0.3

| Scheme ID (κ_{c}, κ_{q}) | 0 (128, 80) | 1 (128, 80) | 2 (192, 110) | 3 (192, 110) | 4 (256, 144) | 5 (256, 144) |
|---|---|---|---|---|---|---|
| (κ_{c}′, κ_{q}) | (139, 90) | (139, 89) | (205, 124) | (206, 124) | (269, 156) | (269, 156) |
| (κ_{c}^{s}, κ_{q}^{s}) | (135, 86) | (135, 85) | (202, 120) | (202, 120) | (266, 154) | (266, 153) |
| (κ_{c}^{Stern}, κ_{q}^{Stern}) | (130, 80) | (131, 80) | (195, 113) | (195, 113) | (257, 145) | (256, 144) |
| (κ_{n,k,w}^{ƒ}, κ_{q}^{ƒ}) | ⊥ | (128, 85) | ⊥ | (210, 127) | ⊥ | (260, 153) |

In this paragraph, we consider improved ISD attacks. We first briefly review

Stern's (1989) algorithm. Let the k×(n+w) matrix G be the public key and c be an RLCE scheme ciphertext. Let

$${G}_{e} = ( \begin{matrix}c \\ G\end{matrix} )$$

be a (k+1)×(n+w) matrix. Stern's algorithm will find the minimal weight code e that is generated by Gₑ. It is straightforward to show that e is the error vector for the ciphertext c. Stern's information set decoding algorithm for finding the vector e is as follows.
1. Select two small numbers p<k/2 and l<n+w−k.
2. Select k columns gᵢ_{₁} , . . . , gᵢ_{ₖ} from Gₑ and l columns gᵢ , . . . , qⱼ_{ₗ} from the remaining n+w−k columns of Gₑ where 0≤i₁ , . . . , iₖ, j₁ , . . . , jₗ≤n+w−1 are distinct numbers. It is expected that the ciphertext c contains 2p errors within the locations i₁ , . . . , iₖ and no errors within the positions j₁ , . . . , jₜ.
3. Let Pᵢ_{₁} , . . . , iₖ, j₁ , . . . , jₗ be a (n+w)×(n+w) permutation matrix so that

GₑPᵢ_{₁} , . . . , iₖ,j₁ , . . . , jₗ=(gᵢ_{₁} , . . . , gᵢ_{ₖ},gⱼ_{₁} , . . . , gⱼ_{ₗ},Gᵣ),

where Gᵣ is a (k+1)×(n+w−k−l) matrix.
4. Compute the echelon format

G_{E}=E(GₑPᵢ_{₁} , . . . , iₖ,j₁ , . . . , jₗ)=SGₑPᵢ_{₁} , . . . , iₖ,j₁ , . . . , jₗ=(I,L,Gᵣ)

where S is a (k+1)×(k+1) matrix.
5. Find random vectors u, v ∈ GF(q)^{(k+1)/2} of weight p such that (u, v)L=0. If no such u, v found, go to Step 2.
6. If (u, v)L=0, then check whether (u, v)Gᵣ has weight t−2p. If it does not have weight t−2p, go to Step 2.
7. If (u, v)Gᵣ has weight t−2p, then e=(u,v)G_{E}Pᵢ_{₁}⁻¹ , . . . , iₖ,j₁ , . . . , kₗ is the error vector for the ciphertext c.

It is noted that if we take p=l=0, then Stern's algorithm is the naive ISD algorithm that we have discussed in the preceding section. For the convenience of analysis, we assume that pl>0 in the following discussion. The algorithm takes approximately

$${S}_{I} = \frac{( \begin{matrix}n + w \\ ⌊ k \text{/} 2 ⌋\end{matrix} ) ( \begin{matrix}n + w - ⌊ k \text{/} 2 ⌋ \\ k - ⌊ k \text{/} 2 ⌋\end{matrix} ) ( \begin{matrix}n + w - k \\ l\end{matrix} )}{( \begin{matrix}n + w - t \\ ⌊ k \text{/} 2 ⌋ - p\end{matrix} ) ( \begin{matrix}t \\ p\end{matrix} ) ( \begin{matrix}n + w - l - ⌊ k \text{/} 2 ⌋ - p \\ k - ⌊ k \text{/} 2 ⌋ - p\end{matrix} ) ( \begin{matrix}t - p \\ p\end{matrix} ) ( \begin{matrix}n + w - t - k + 2 p \\ l\end{matrix} )} \qquad ( 6 )$$

iterations. For each iteration, Step 4 takes (2n+2w−k)k² field operations, and Step 5 takes 2(ₚ^{k/2) (q-}1)^{p}l(k+1) field operations. For each iteration, Step 6 runs (ₚ^{k/2})²(q−1)^{2p-l} times approximately and each runs takes (n−k−l)(k+1) field operations. In a summary, Stern's ISD takes approximately 2^{κ}^{_{c}} steps to find the error vector e where,

κ_{c}=min_{p,l}{log₂(S_{I}((2n+2w−k)k²+2(ₚ^{k/2})(q−1)^{p}l(k+1) +(ₚ^{k/2})²(q−1)^{2p-l}(n−k−l))}. (7)

Our experiments show that for RLCE schemes that we have interest in, the equation (7) is always achieved with p=1 and l=3. For quantum version of Stern's ISD algorithm, the Grover's algorithm could be used to reduce the iteration steps to \sqrt{Sᵣ}. Thus the quantum security level under Stem attacks is approximately

κ_{q}=min_{p,l},{log₂ (\sqrt{S₁}((2n+2w−k)k²+2(ₚ^{k/2})(q−1)^{p}l(k+1)+(ₚ^{k/2})²(q−1)^{2p-l}(n−l−l))}. (8)

In order to speed up Stern's algorithm, Peters (2010) considers the following improvement:
1. For each iteration, one does not randomly selects k columns from Gₑ in Step 2. Instead, one reuses k−c columns from the previous iteration where c is a fixed constant.
2. For a small finite field, fix a parameter r>1 for certain pre-computation of row sums. This will not provide any benefit for a large field size such as those used in RLCE schemes.
3. For a small finite field, fix a parameter m>1 such that one can use m error-free sets of size l. This will not provide any benefit for a large field size such as those used in RLCE schemes.
   Our experiments show that for κ_{c}≤200, Peters's improved version is at most 8 times fast than Stern's algorithm discussed in this section. That is, we generally have κ_{c}−3≤κ_{c}^{Peter}≤κ_{c} where κ_{c}^{Peter} is the κ_{c} obtained from Peter's improved algorithm. For κ_{c}≥250, our experiments show that Peter's improved version has the same performance as Stern's algorithm discussed in this section. Furthermore, our experiments show that the optimal values for p, l in Peter's improved algorithm on all RLCE schemes are p=1 and l=3 also.

Using distinguisher techniques by Faugere (2013), Couvreur et al. (2013) designed a filtration technique to attack GRS code based McEliece scheme. The filtration technique was further developed by Couvreur et al (2014) to attack wild Goppa code based McEliece scheme. In the following, we briefly review the filtration attack in Ccouvreur et al (2014). For two codes C₁ and C₂ of length n, the star product code C₁*C₂ is the vector space spanned by a*b for all pairs (a, b) ∈ C₁×C₂ where

a*b=[a₀b₀, a₁b₁ , . . . , aₙ₋₁bₙ₋₁].

For the square code C²=C*C of C, we have

$$dim {C}^{2} \leq min \{ n , ( \begin{matrix}dim C + 1 \\ 2\end{matrix} ) \} .$$

For an [n, k] GRS code C, let a, b ∈ GRSₖ(x, y) where a=(y₀p₁(x₀), . . . , yₙ₋₁p₁(xₙ₋₁)) and b=(y₀p₂(x₀), . . . , yₙ₋₁p₂(xₙ₋₁)). Then a*b=(y₀²p₁(x₀)p₂(x₀), . . . , yₙ₋₁²p₁(xₙ₋₁)p₂(xₙ₋₁)). Thus GRSₖ(x, y)² ⊆ GRS₂ₖ₋₁(x, y*y) where we assume 2k−1≤n.

Let G be the public key for an (n, k, d, t, w) RLCE encryption scheme based on a GRS code. Let C be the code generated by the rows of G. Let D₁ be the code with a generator matrix D₁ obtained from G by replacing the randomized 2w columns with all-zero columns and let D₂ be the code with a generator matrix D₂ obtained from G by replacing the n−w non-randomized columns with zero columns. Since C⊂D₁+D₂ and the pair (D₁, D₂) is an orthogonal pair, we have C²⊂D₂²+D. It follows that

2k−1≤dim C²≤min{2k−1,n−w}2w (9)

where we assume that 2w≤k². In the following discussion, we assume that the 2w randomized columns in D₂ behave like random columns in the filtration attacks. We first consider the simple case of k≥n−w. In this case, we have dim C²=D₁²+D₂²=n−w+D₂²=n+w. Furthermore, for any code C′ of length n′ that is obtained from C using code puncturing and code shortening, we have dim C′²=n′. Thus filtration techniques could not be used to recover any non-randomized columns in D₁.

Next we consider the case for k<n−w. For this case, we distinguish two sub-cases: n−w≥2k and n−w<2k. For the case n−w≥2k, let Cᵢ be the punctured C code at position i. We distinguish the following two cases:
Column i of G is a randomized column: the expected dimension for is Cᵢ² is 2k+2w−2.
Column i of G is a non-randomized column: the expected dimension for is Cᵢ² is 2k+2w−1.
   This shows that if n−w≥2k, then the filtration techniques could be used to identify the randomized columns within the public key G. Thus it is recommended to have n−w <2k for RLCE scheme.

Now we consider the case of k<n−w<2k. In order to carry out filtration attacks, we need to shorten the code C at certain locations. Assume that we shorten l<k−1 columns from G. Among the l=l₁+l₂ columns, l₁ columns are non-randomized columns from D₁ and l₂ columns are randomized columns from D₂. Then the shortened code has dimension

d_{l,l}_{₁}=min{(k−l)², min{2(k−l₁)−1,n−w−l₁,(k−l)²}+min{2w−l₂,(k−l)²}}. (10)

A necessary condition for the filtration attack to be observable is that, after the shortening of the l₁ columns in D₁, the following condition is satisfied

d_{l,l}_{₁}=2(k−l₁)−1+min{2w−l₂,(k−l)²}. (11)

Thus for a given l, the probability for the filtration attack to be successful is bounded by the probability

$$\frac{{\sum }_{{l}_{1} = max \{ 0 , l - 2 w \}}^{l} λ ( {d}_{l , {l}_{1}} ) ( \begin{matrix}n - w \\ {l}_{1}\end{matrix} ) ( \begin{matrix}2 w \\ l - {l}_{1}\end{matrix} )}{( \begin{matrix}n + w \\ l\end{matrix} )}$$

where λ(d_{l,l}_{₁})=1 if (11) holds and λ(d_{l,l}_{₁})=0 otherwise. For a given 1, one randomly selects l columns from G and shortens G from these locations. This process takes O (kl(n+w)) field operations. Then one calculates the dimension of the shortened code to see whether the equation (11) is achieved which takes O ((k−l)⁴(n+w−l)) field operations. In a summary, the expected time for one to carry out the filtration attack for a given l is

$${PF}_{n , k , w , l} = \frac{( \begin{matrix}n + w \\ l\end{matrix} ) ( O ( kl ( n + w ) ) + O ( {( k - l )}^{4} ( n + w - l ) ) )}{{\sum }_{{l}_{1} = max \{ 0 , l - 2 w \}}^{l} λ ( {d}_{l , {l}_{1}} ) ( \begin{matrix}n - w \\ {l}_{1}\end{matrix} ) ( \begin{matrix}2 w \\ l - {l}_{1}\end{matrix} )}$$

Let

κ_{n,k,w}^{ƒ}=log₂ min{PF_{n,k,w,l}:2k−n+w≤l≤k−2}. (12)

Then in order to guarantee that the RLCE scheme is secure against filtration attacks, the parameters should be chosen in such a way that “n−w≤k” or “n−w<2k and κ_{c}≤κ_{n,k,w}^{ƒ}.”

Filtration attacks could be combined with Grover's quantum search algorithm. The quantum Filtration attacks works in the same way as the filtration attack that we have discussed in the preceding paragraph except that one uses Grover's quantum computer to select 1 columns from the public key C. It can be shown that, under quantum filtration attacks, the attack against the RLCE scheme takes

$${min}_{2 k - n + w \leq l \leq k - 2} \{ \frac{7 \cdot {( {log}_{2} q )}^{1.585} \cdot ( O ( kl ( n + w ) ) + O ( {( k - l )}^{4} ( n + w - l ) ) ) \sqrt{( \begin{matrix}n + w \\ l\end{matrix} )}}{\sqrt{{\sum }_{{l}_{1} = max \{ 0 , l - 2 w \}}^{l} λ ( {d}_{l , {l}_{1}} ) ( \begin{matrix}n - w \\ {l}_{1}\end{matrix} ) ( \begin{matrix}2 w \\ l - {l}_{1}\end{matrix} )}} \} . \qquad ( 13 )$$

steps.

For each of the recommended schemes in Table 0.3, the row (κ_{n,k,w}^{ƒ}, κ_{q}^{ƒ}) in Table 0.2 shows the security strength under the filtration attack and quantum filtration attacks. For example, the RLCE scheme with ID=1 in Table 0.3 has 128-bits security strength under filtration attacks and 85-bits security strength under quantum filtration attacks.

We mentioned several attacks on RLCE schemes in the preceding paragraphs. To avoid these attacks, it is necessary to use message padding schemes so that the encryption scheme is secure against adaptive chosen ciphertext attacks (IND-CCA2).

We first analyze the amount of information that could be encoded within each ciphertext. Let (n, k, t, w) be the parameters where the public key is of dimension k×(n+w) and G F(q) (with q=2^{m}) be the underlying finite field. There are three approaches to encode messages within the ciphertext.
1. basicEncoding: Encode information within the vector m ∈ GF(q)^{k} and the ciphertext is c=mG+e. In this case, we can encode mLen=mk bits information within each ciphertext.
2. mediumEncoding: In addition to basicEncoding, further information is encoded in the non-zero entries of e. That is, let eᵢ_{₁} , . . . , eᵢ_{ₜ}∈ G F(q)\{0} be the non-zero elements within e and encode further information within eᵢ_{₁} , . . . , eᵢ_{ₜ}. In this case, we can encode mLen=m(k+t) bits information within each ciphertext. Strictly speaking, the encoded information is less than m(k+t) bits since cannot be zeros.
3. advancedEncoding: In addition to mediumEncoding, further information are encoded within locations of non-zero entries within e. Since there are

$$( \begin{matrix}n + w \\ t\end{matrix} )$$

candidates for the choice of non-zero entries within e, we can encode

$$mLen = m ( k + t ) + ⌊ {log}_{2} ( \begin{matrix}n + w \\ t\end{matrix} ) ⌋$$

bits information within each ciphertext.

The basicEncoding approach is straightforward. For the mediumEncoding, after one recovers the vector m, one needs to compute mG−c to obtain the values of eᵢ_{ₜ} , . . . , eᵢ_{ₜ}. For the advancedEncoding approach, we need to compute an invertible function

$$ϕ \text{:} {W}_{n + w , t} ↔ \{ i \text{:} 1 \leq i \leq ( \begin{matrix}n + w \\ t\end{matrix} ) \} \qquad ( 14 )$$

where W_{n+w,t} ⊆ GF(2)^{n+w} is the set of all (n+w)-bit binary string of weight t. For the invertible function φ in (14), one may use the enumerative source encoding construction in Cover (1973):

$$ϕ \text{:} {W}_{n + w , t} ↔ [ 0 , ( \begin{matrix}n + w \\ t\end{matrix} ) ]$$

where

$$ϕ ( {i}_{1} , ⋯ , {i}_{t} ) = ( \begin{matrix}{i}_{t} - 1 \\ t\end{matrix} ) + ⋯ + ( \begin{matrix}{i}_{1} - 1 \\ 1\end{matrix} )$$

and 0≤i₁<i₂<. . . <iₜ<n+w are the positions of ones. The function φ could be evaluated with the cost of

$$O ( {( {log}_{2} ⌈ ( \begin{matrix}n + w \\ t\end{matrix} ) ⌉ )}^{2} )$$

operations (see, e.g., Sendrier 2005).

We assume that the message bandwidth is mLen-bits for each ciphertext. We present two efficient IND-CCA2 padding schemes for the RLCE encryption scheme. Our padding schemes are adapted from the well analyzed Optimal Asymmetric Encryption Padding (OAEP) for RSA/Rabin encryption schemes and its variants OAEP+(Shoup 2001) and SAEP+(Boneh 2001). The first simple padding scheme RLCEspad is a one-round of a Feistel network that is similar to SAEP+. RLCEspad could be used to encrypt short messages (e.g., mLen/4-bits) and is sufficient for applications such as symmetric key transportation using the RLCE public key encryption scheme. The second padding scheme RLCEpad is a two-round Feistel network that is similar to OAEP+. RLCEpad could be used to encrypt messages that are almost as long as mLen-bits. In the following discussions, we assume that messages are binary strings. After padding, it will be converted to field elements and/or other information required for the RLCE scheme. For a RLCE setup process RLCE.KeySetup(n, k, d, t, w), let k×(n+w) matrix G be a public key and (S, Gₛ, P₁, P₂, A) be a corresponding private key. The RLCEspad proceeds as follows.

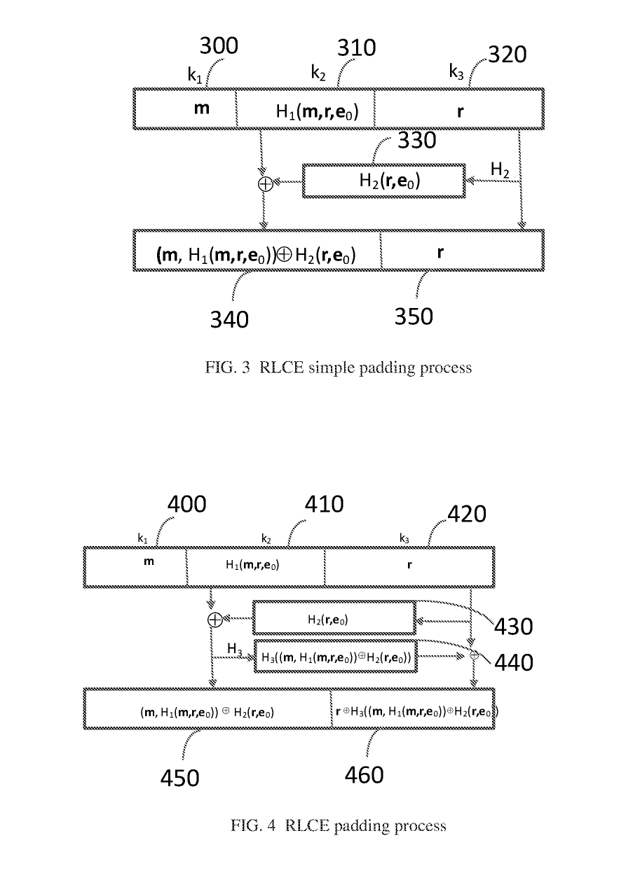

FIG. 3 describes a process for the padding scheme RLCEspad(mLen, k₁, k₂, k₃). Referring therefore to FIG. 3, let k₁, k₂, k₃ be parameters such that mLen=k₁+k₂+k₃, k₁+k₂<k₃, and k₁≤mLen/4. Let H₁ and H₂ be random oracles that take any-length inputs and outputs k₂-bytes and (k₁+k₂)-bytes respectively. The box 300 is the message m ∈ {0, 1}^{8k}^{₁} to be encrypted and the box 320 is a randomly selected binary sequence r ∈ {0, 1}^{8k}^{₃}. The random oracle engine 310 outputs a k₂-bytes sequence H₁ (m, r, e₀) on the inputs m, r, e₀. The random oracle engine 330 outputs a (k₁+k₂)-bytes sequence H₂(r, e₀) on the inputs r, e₀. The exclusive-or engine 340 outputs a (k₁+k₂)-bytes sequence (m∥H₁(m,r,e₀))⊕H₂(r,e₀). The copy engine 350 outputs the value in the box 320.

Specifically, RLCEspad could be described for various encoding methods that we have discussed in the preceding paragraphs. We distinguish the following three cases:
basicEncoding: select a random e ∈ GF(q)^{n+w} of weight t and set

y=((m∥H₁(m,r,e))⊕H₂(r,e))∥r (15)

Convert y to an element yₗ ∈ GF(q)^{k}. Let the ciphertext be c=y₁G+e.
mediumEncoding: select a random e₀ ∈ W_{n+w,t} and set

y=((m∥H₁(m,r,e₀)) ⊕ H₂(r,e₀))∥r. (16)
Convert y to an element y₁ ∈ GF(q)^{k} and an element eₗ ∈ GF(q)^{t}. Integrate eₗ within e₀ to form an error vector e ∈ GF(q)^{n+w} of weight t. Let the ciphertext be c=y₁G+e.
advancedEncoding: set y=((m∥H₁(m, r) ⊕ H₂ (r))∥r. Convert y to an element y₁ ∈ GF(q)^{k} and a vector e ∈ GF(q)^{n+w} of weight t. Let the ciphertext be c=y₁G+e.

Assuming the hardness of decoding RLCE ciphertexts, a similar proof as in Boneh (2001) could be used to show that RLCE-RLCEspad scheme is secure against IND-CCA2 attacks. As an example with κ_{c}=128 bits security RLCE scheme (600, 464, 68) over GF(2¹⁰) in Table 0.3, we use k₁=k₂=160-bytes for mediumEncoding and k₁=k₂=170-bytes for advancedEncoding.

FIG. 4 describes a process for our next padding scheme RLCEpad(mLen, k₁, k₂, k₃) reported in this invention. Referring therefore to HG. 4, let k₁, k₂, k₃ be parameters such that mLen=k₁+k₂+k₃ and H₁, H₂, and H₃ be a random oracle that takes any-length inputs and outputs k₂, k₂, and k₃ bits respectively. Let The box 400 is the message m ∈{0, 1}^{8k}^{₁} to be encrypted and the box 420 is a randomly selected binary sequence r ∈{0, 1}^{8k}^{₃}. The random oracle engine 410 outputs a k₂-bytes sequence Hᵢ (m, r, e₀) on the inputs m, r, e₀. The random oracle engine 430 outputs a (k₁+k₂)-bytes sequence H₂(r, e₀) on the inputs r, e₀. The random oracle engine 440 outputs a k₃-bytes sequence H₃((M∥H₁(m, r, e₀)) ⊕ H₂(r, e₀)). The exclusive-or engine 450 outputs a (k₁+k₂)-bytes sequence (m∥H₁(m, r, e₀)) ⊕ H₂(r, e₀) The exclusive-or engine 460 outputs a k₃-bytes sequence r ⊕ H₃((m∥H₁(m, r, e₀)) ⊕ H₂(r, e₀)).

Specifically, RLCEpad could be described for various encoding methods that we have discussed in the preceding paragraphs. We distinguish the following three cases:
basicEncoding: select a random e ∈ GF(q)^{n+w,t} of weight t and set

y=((m∥H₁(m,r,e)) ⊕ H₂(r,e))∥r⊕ H₃(((m∥H₁(m,r,e)) ⊕ H₂(r,e))) (17)

Convert y to an element y₁ ∈ GF(q)^{k}. Let the ciphertext be c=y₁G+e.
mediumEncoding: select a random e₀ ∈ W_{n+w,t} and set

y=((m∥H₁(m, r, e₀)) ⊕ H₂(r, e₀))∥(r⊕H ₃((m∥H₁(m,r,e₀)) ⊕ H₂(r,e₀))) (18)

Convert y to an element y₁ ∈ GF(q)^{k} and an element eₗ ∈ GF(q)^{t}. Integrate eₗ within e₀ to form an error vector e ∈ GF(q)^{n+w} of weight t. Let the ciphertext be c=y₁G+e.
advancedEncoding: set

y=((m∥H₁(m,r))⊕ H₂(r))∥(r⊕ H₃((m∥H₁(m,r))⊕ H₂(r))) (19)

Convert y to an element y₁ ∈ GF(q)^{k} and a vector e ∈ GF(q)^{n+w} of weight t. Let the ciphertext be c=y₁G+e.

Assuming the hardness of decoding RLCE ciphertexts, a similar proof as in Shoup (2001) could be used to show that RLCE-RLCEpad scheme is secure against IND-CCA2 attacks. As an example with κ=128 bits security RLCE scheme (600, 464, 68) over GF(2¹⁰) in Table 0.3, we use k₂=32-bytes and k₃=33-bytes for both mediumEncoding and advancedEncoding.

Note that either error positions e₀ or error vector e is used in the RLCEspad/RLCEpad schemes and the message recipient needs to have the exact e₀ or e for message decoding. In case that the randomly generated error values contain zero field elements, the corresponding error positions will be unavailable for the recipient. To avoid this potential issue, the message encryption process needs to guarantee that error values should never be zero. A simple approach to address this challenge is when calculated error values (using the given random value r) contain zero field elements, one revises the random value r to a new value and tries the padding approach again. This process continues until all error values are non-zero.

Taking into account of the cost of Sidelnikov-Shestakov attacks, the cost of recovering McEliece encryption scheme secret keys from the public keys, and the cost of recovering plaintext messages from ciphertexts using the information-set decoding methods, we generated a recommended list of parameters for RLCE scheme in Table 0.3. In particular, the recommendation takes into account of the conditions for avoiding improved classical and quantum information set decoding, the conditions for avoiding Sidelnikov-Shestakov attacks, the conditions for filtration attacks (with or without brute force), the cost of recovering McEliece encryption scheme secret keys from the public keys, and the cost of recovering plaintext messages from ciphertexts. In Table 0.3, n, denotes the conventional security strength and κ_{q} denotes the quantum security strength. For example, κ_{c}=128 means an equivalent security of AES-128. The recommended parameters is based on any underlying MDS linear code (e.g., GRS code) over GF(q) where q=2^{[log}^{₂}^{n]}. For GRS codes, the BCH-style construction requires n=q−1. However, GRS codes could be shortened to length n<q−1 codes by interpreting the unused q−1−n information symbols as zeros.

In Table 0.3, the schemes with ID=0, 1, 2, 3, 4, 5, 6 are for MDS codes with

$$t = \frac{n - k}{2} .$$

The scheme with ID=6 is for testing purpose only.

Table 0.3 also lists the message bandwidth and message padding scheme parameters

TABLE 0.3
Padding parameters: bE for basicEncoding, mE for mediumEncoding and aE for advancedEncoding

| | | | | | | RLCEspad | | RLCEpad | |
|---|---|---|---|---|---|---|---|---|---|
| | | | | | | κ₁ | | | κ₂ |
| ID | κ_{c}, κ_{q}, n, k, t, w, m | sk | cipher, pk | | mLen | (κ₂) | κ₃ | κ₁ | (κ₃) |
| 0 | 128, 80, 630, 470, 80, 160, 10 | 310116 | 988, 188001 | bE | 4700 | 146 | 296 | 524 | 32 |
| | | 192029 | | mE | 5500 | 171 | 346 | 624 | 32 |
| | | | | aE | 5869 | 183 | 368 | 670 | 32 |
| 1 | 128, 80, 532, 376, 78, 96, 10 | 179946 | 785, 118441 | bE | 3760 | 117 | 236 | 406 | 32 |
| | | 121666 | | mE | 4540 | 141 | 286 | 504 | 32 |
| | | | | aE | 4875 | 152 | 306 | 546 | 32 |
| 2 | 192, 110, 1000, 764, 118, 236, 10 | 747393 | 1545, 450761 | bE | 7640 | 238 | 479 | 859 | 48 |
| | | 457073 | | mE | 8820 | 275 | 553 | 1007 | 48 |
| | | | | aE | 9377 | 293 | 587 | 1077 | 48 |
| 3 | 192, 110, 846, 618, 114, 144, 10 | 440008 | 1238, 287371 | bE | 6180 | 193 | 387 | 677 | 48 |
| | | 292461 | | mE | 7320 | 228 | 459 | 819 | 48 |
| | | | | aE | 7825 | 244 | 491 | 883 | 48 |
| 4 | 256, 144, 1360, 800, 280, 560, 11 | 1773271 | 2640, 1232001 | bE | 8800 | 275 | 550 | 980 | 60 |
| | | 1241971 | | mE | 11880 | 371 | 743 | 1365 | 60 |
| | | | | aE | 13025 | 407 | 815 | 1509 | 60 |
| 5 | 256, 144, 1160, 700, 230, 311, 11 | 1048176 | 2023, 742089 | bE | 7700 | 240 | 483 | 843 | 60 |
| | | 749801 | | mE | 10230 | 319 | 641 | 1159 | 60 |
| | | | | aE | 11145 | 348 | 698 | 1274 | 60 |
| 6 | 22, 22, 40, 20, 10, 5, 10 | 1059 | 57, 626 | bE | 200 | 6 | 13 | 17 | 4 |
| | | 859 | | mE | 300 | 9 | 20 | 30 | 4 |
| | | | | aE | 331 | 10 | 22 | 34 | 4 |

for the recommended schemes. In case that v=8(k₁+k₂+k₃)−mLenᵢ>0, the last v-bits of the k₃-bytes random seed r should be set to zero and the last v-bit of the encoded string y is discarded. For RLCEspad with v>0, the encoding and decoding process are straightforward. For RLCEpad with v>0, the decoding process produces an encoded string y with last v-bits missing. After using H₃ to hash the first part of y resulting in k₃-bytes hash output, one discards the last v-bits from the hash output and ⊕ the remaining (8k₃−v)-bits with the second half of y to obtain the (8k₃−v)-bits of r without the v-bits zero trailer. In the column for sk, the first row is the private key size for RLCE scheme with decoding algorithm 1 and 3. The second row is the private key size for RLCE scheme with decoding algorithm 2.

### REFERENCE CITED

Marco Baldi, Marco Bianchi, Franco Chiaraluce, Joachim Jakob Rosenthal, and Davide Mose' Schipani. Method and apparatus for public-key cryptography based on error correcting codes. U.S. Pat. No. 9,191,199 B2 (2015)
Martin Tomlinson, Cen Jung Tjhai. Public key cryptosystem based on goppa codes and puf based random generation. U.S. Pat. No. 8,958,553 B2 (2015)
Martin Tomlinson and Cen Jung Tjhai. Public key encryption using error correcting codes. WO2012066328 A1 (2012)
Eran Kanter, Ido Kanter. A secure and linear public-key cryptosystem based on parity-check error-correcting code. WO2001050675 A2 (2001).
Yongge Wang. Method and Apparatus for Random Linear Code Based Public Key Encryption Schemes. U.S. patent application Ser. No. 15/270,824, filed on Sep. 20, 2016.
Yongge Wang. Method and Apparatus for Quantum Resistant Public Key Encryption Scheme RLCE and IND-CCA2 Security. U.S. Patent application U.S. 62/435,151, filed on Dec. 16, 2016.

What is claimed.

1. A method for transmitting a message vector m between a sender and a receiver securely, the method comprising:
a) at the receiver: obtaining a k×n generator matrix Gₛ for an [n, k, d] linear code over a finite field GF(q), wherein n, k, d, q are positive integers; obtaining a k×(n+w) matrix G₁ by inserting w random columns into said matrix Gₛ, wherin w is a positive integer; selecting a random k×k non-singular matrix S; selecting a random (n+w)×(n+w) non-singular matrix A; selecting a random (n+w)×(n+w) permutation matrix P; setting a public key G=SG₁AP; sending the public key G to the sender; and setting a private key K=(S, Gₛ, A, P);
b) at the sender: obtaining said integer n; obtaining said integer k; obtaining said finite field GF(q); obtaining said message encryption public key G; obtaining said message vector m; obtaining an integer t; generating an error vector e wherin e has said weight t; computing a ciphertext vector y=mG+e; and sending said ciphertext vector y to said receiver;
c) at the receiver: obtaining said ciphertext vector y from the sender; computing an inverse matrix P⁻¹ of said permutation matrix P; computing an inverse matrix A⁻¹ of said non-singular matrix A; computing an inverse matrix S⁻¹ of said non-singular matrix S; computing a vector yP⁻¹ A⁻¹; selecting a sub-vector y′ of said vector yP¹ A¹ wherin said vector y′ has said length n; using said generator matrix Gₛ to decode said subvetor y′ to a vector m′ wherin m′ has said length k; computing said plaintext message m=m′S¹; and checking a validity of said message m.

2. The method of claim 1 wherein computing said k×(n+w) matrix G₁ comprises:
a) obtaining matrix columns g₀ , . . . , gₙ₋₁ from said generator matrix Gₛ;
b) selecting random k×1 matrices C₀, C₁ , . . . , C_{w-1} over said GF(q); and
c) obtaining said k×(n+w) matrix G₁=[g₀, g₁ , . . . , g_{n-w}, C₀ , . . . , gₙ₋₁, C_{w-1}].

3. The method of claim 1 wherein selecting said non-singular matrix A comprises:
a) selecting random 2×2 matrices A₀, A₁ , . . . , A_{w-1} over said GF(q); and
b) obtaining said (n+w)×(n+w) matrix
$$A = diag [ {I}_{n - w} , {A}_{0} , ⋯ , {A}_{w - 1} ] = [ \begin{matrix}{I}_{n - w} & & & \\ & {A}_{0} & & \\ & & ⋱ & \\ & & & {A}_{w - 1}\end{matrix} ]$$
wherein I_{n-w} is an identity matrix of dimension n−w.

4. The method of claim 3 wherein said k×(n+w) matrix G₁ is selected according to the method of claim 2.

5. The method of claim 4 wherein selecting said subvector y′ comprises:
a) obtaining elements y′₀ , . . . , y′_{n+w-1} of said vector yP⁻¹ A⁻¹; and
b) setting said sub-vector y′=[y′₀,y′₁ , . . . , y′_{n-w};y′_{n-w+2} ; . . . , y′_{n+w-2}].

6. The method of claim 5 wherein checking said validity of said message m, comprises:
a) computing a Hamming weight w=weight (y−Mg); and
b) accepting said message m, if w≤t.
